(19) United States
(12) Patent Application Publication
(10) Pub. No.: US 2019/0144245 A1
(43) Pub. Date: May 16, 2019

(54) Slab Lifting Clamp

(71) Applicant: James Edmund Corbett, Crows Nest (AU)

(72) Inventor: James Edmund Corbett, Crows Nest (AU)

(21) Appl. No.: 16/189,081

(22) Filed: Nov. 13, 2018

Related U.S. Application Data
(60) Provisional application No. 62/585,082, filed on Nov. 13, 2017.

(51) Int. Cl. B66C 1/44

(52) U.S. Cl. CPC B66C 1/442; B66C 1/48

(57) ABSTRACT

A disclosed gripping system for lifting planar objects comprises a back plate, center sliding plate, lifting pin assembly and cam plate in pivotal connection. Slabs of granite, concrete, marble and other dense planar objects may be safely lifted, moved and lowered, with automatic locking and unlocking of the planar object occurring in response to either the gripping system being lowered upon the planar object, or the planar object being deposited upon the ground.

### CROSS-REFERENCE TO RELATED APPLICATIONS

This is a utility application based upon U.S. patent application Ser. No. 62/585,082 filed on Nov. 13, 2017. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademarks may include “Aardwolf”, “Aardwolf Lifter”, “Aardwolf Lifter-Auto Lock” and “Aardwolf Industries.”

### BACKGROUND OF THE INVENTION

### (1) Field of the Invention

The invention generally relates to lifting systems. More particularly, the invention relates to means and methods of creating an auto locking clamp useful for gripping and transporting sheet material such as slabs comprising relatively dense material such as granite, engineered quartz, masonry, concrete, marble, metal and other engineered slabs.

### (2) Description of the Related Art

The known related art fails to anticipate or disclose the principles of the present invention.

Thus, there is a need in the art for the present invention.

### BRIEF SUMMARY OF THE INVENTION

The present invention overcomes shortfalls in the related art by presenting an unobvious and unique combination and configuration of methods and components to provide an auto locking and auto opening clamp system having five or so positions or movements instrumental in safely and reliably clasping or otherwise retaining a sheet of material.

The invention overcomes shortfalls in the related art by using a locking pin axially disposed within cylinder, the cylinder defined or contained within the upper or superior end of a lifting pin assembly. The locking pin may travel vertically and rotate to facilitate the five or so positions used to grasp, lift and release a planar object. A lifting pin assembly is pivotally attached and integrated with a back plate, center sliding plate and cam plate to first grasp a sheet product upon contact, allow for the vertical and horizontal movement and suspension of the sheet product and then release the sheet product when the sheet product has been lowered to a resting position. The clamping and unclamping of the sheet product or payload occurs in automatic reaction to the disclosed systems being raised and lowered.

Disclosed embodiments overcome shortfalls in the related art by maximizing the surface area used to secure a sheet product and by maximizing the pressure exerted to close the clamping surfaces.

In general, disclosed systems and/or methods of use include:

Upon lowering the lifting arm, the locking pin goes into the locking recess mounted on the top of the cam plate and then rotates 45°. As the lifting arm is raised, the locking pin rotates a further 45°. At this point the lifting arm is locked in place. The lifting arm remains locked until the action is cycled, which then rotates the locking pin and unlocks the lifting arm from the locking recess.

It is an object of the present invention to provide an improved, safer slab handling apparatus that is suitable for handling a variety of heavy slab-shaped loads.

A disclosed slab lifting clamp fitted with the auto lock, unlock mechanism can be placed on the slab without the risk of a worker standing in the fall shadow zone of the slab.

In accordance with another aspect of the invention, a disclosed device can be utilized in a relatively confined area, as it requires a minimum amount of space around the periphery of the slab for gripping and transporting slab material.

These and other objects and advantages will be made apparent when considering the following detailed specification when taken in conjunction with the drawings.

### BRIEF DESCRIPTION OF THE DRAWINGS

FIG. 1 depicts a sectional side view of a disclosed embodiment

FIG. 2 depicts an elevational view of a back plate

FIG. 3 depicts an exploded view of a disclosed embodiment

FIG. 4 depicts an exploded view of a lifting pin assembly

FIG. 5 depicts a perspective view of a lifting pin assembly

FIG. 6 depicts a disclosed embodiment in a locked position

FIG. 7 depicts a disclosed embodiment with a lifting arm lowered and locking pin rotated by 45 degrees

FIG. 8 depicts a disclosed embodiment with the lifting arm raised and the locking pin further rotated another 45 degrees

FIG. 9 depicts a disclosed embodiment with the lifting arm raised

FIG. 10 depicts a disclosed embodiment with the lifting arm lowered and locking pin rotated 45 degrees

FIG. 11 depicts a disclosed embodiment with the lifting arm raised with the locking pin further rotated another 45 degrees, locking the pin back to a locked position, as in FIG. 6

FIG. 12 depicts a top perspective view of FIG. 6

FIG. 13 depicts a top perspective view of FIG. 7

FIG. 14 depicts a top perspective view of FIG. 8

FIG. 15 depicts a top perspective view of FIG. 9

FIG. 16 depicts a top perspective view of FIG. 10

### REFERENCE NUMERALS IN THE DRAWINGS

100 a disclosed embodiment in general

1 hexagon socket countersunk head screw m1×40 or fastener

2 hexagon socket countersunk head screw m1×40 or fastener

3 back plate

4 rubber or other relatively soft material for back plate

5 tapping screw

6 rubber or other relatively soft material for sliding plate

7 center sliding plate

8 circlips

9 outer pressure wheel

10 shaft

11 inner pressure wheel

12 rubber pieces

13 bottom extension spring

14 cam plate

15 rubber for cam plate

16 brass washer

17 plastic cap

18 locking pin or locking plunger

19 lifting pin

20 hexagon socket counter sunk head screw M6×10

21 cylinder

30 locking pin base

35 center sliding plate

200 lifting pin assembly

205 top half section of lifting pin 19

210 upper void defined within top half section 205 of lifting pin 19

220 lower pivot mounts of lifting pin 19

230 upper rotational pivot plane assembly of locking pin 18

240 triangular lock head or plunger of locking pin

250 face of lifting pin

300 locking recess defined within the center sliding plate 7

400 lifting arm

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

FIG. 1 depicts a sectional view of a disclosed embodiment wherein a locking pin assembly comprises a lower roller assembly in rotational contact with a cam plate and center sliding plate. Optimally using the downward gravitational force of a payload, the center sliding plate is urged into the back plate, trapping the payload, the payload being disposed between the center sliding plate and back plate. Vertical movement of a disclosed embodiment, in relation to a payload, automatically opens and closes the center sliding plate and back plate.

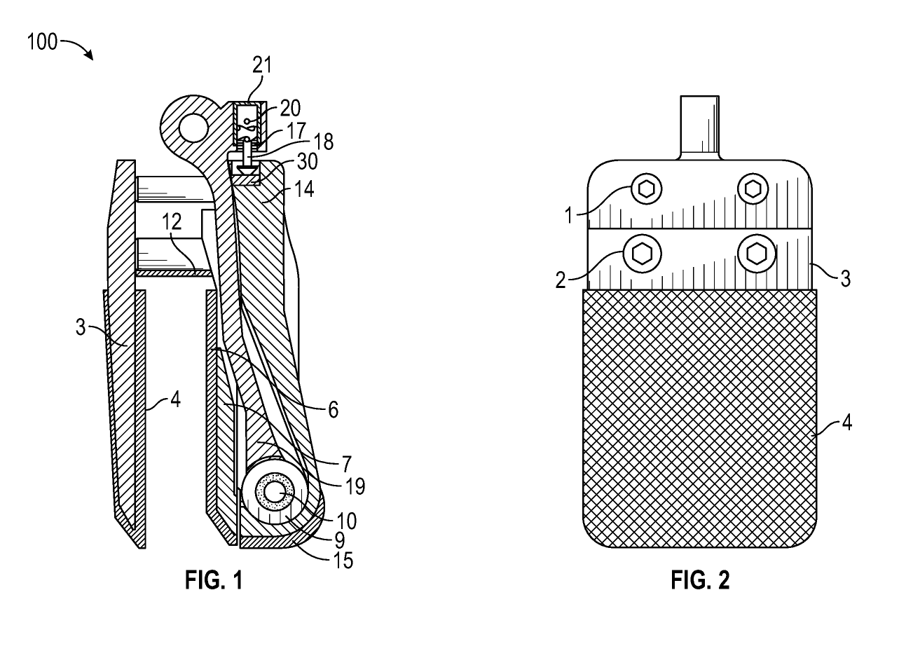

FIG. 2 depicts an elevational view of a back plate secured by four fasteners.

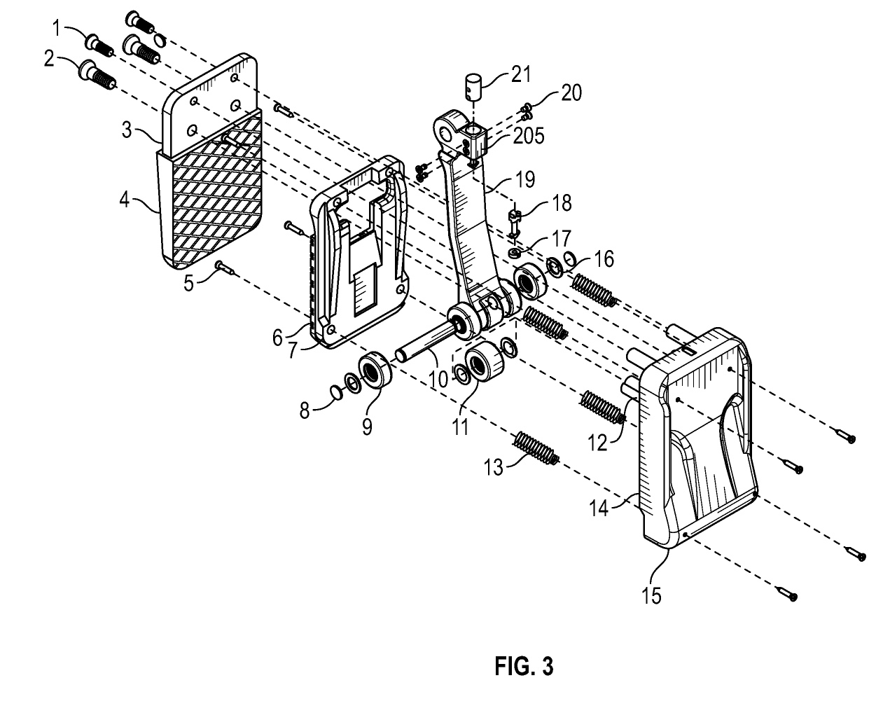

FIG. 3 depicts an exploded view of a disclosed embodiment highlighting the means of attachment of the disclosed components. Disclosed components may include a back plate 3 having a top half, the top half defining a plurality of voids with the voids sometimes used by fasteners 1 and 2, with the fasteners also secured through a center sliding plate 7 and a cam plate 15.

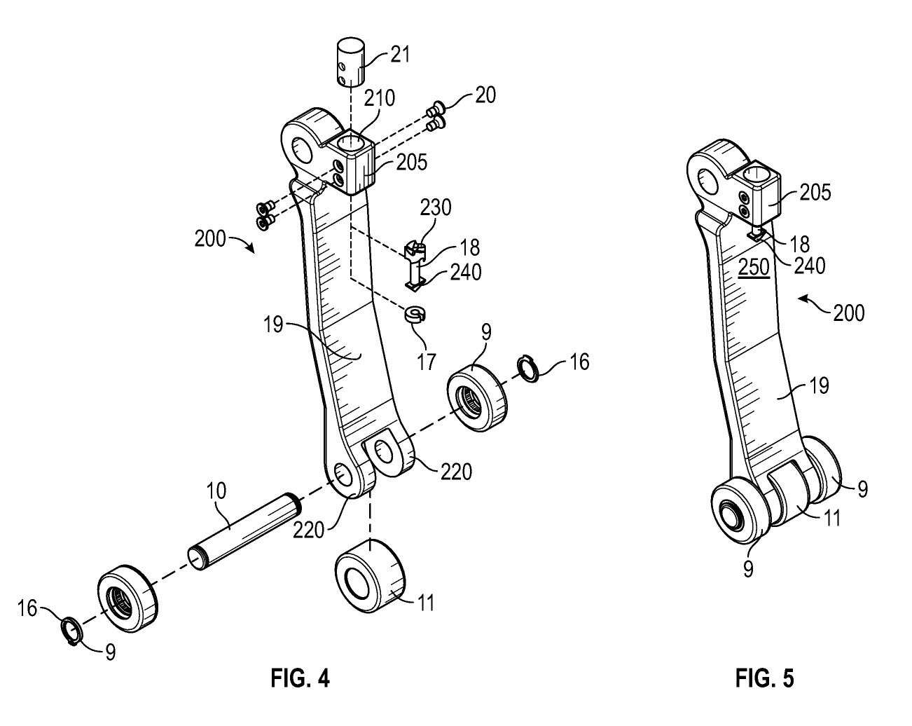

FIG. 4 depicts an exploded view of a disclosed lifting pin assembly 200 wherein a top half 205 or superior side may define or include a cylinder void 210, the cylinder void comporting to a cylinder 21. A lifting pin assembly may further comprise one or more pressure wheels, the pressure wheels used to open or close the back plate and center sliding plate as a payload interacts with the embodiment.

FIG. 5 depicts a perspective view of a lifting pin assembly 200. The locking pin 18 is in a lowered position with the locking plunger or triangular lock head 240 parallel to the face 250 of the lifting pin.

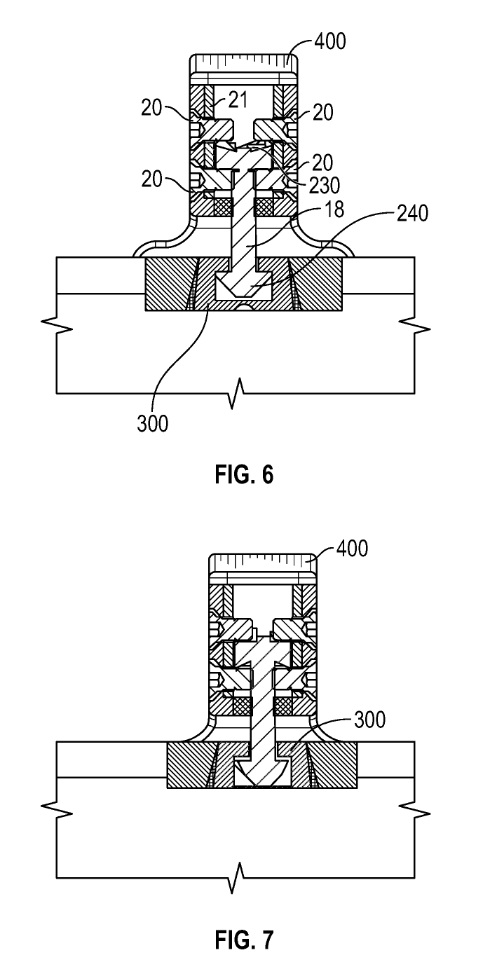

FIG. 6 depicts an embodiment in a locked position.

FIG. 7 depicts an embodiment with a lifting arm lowered and the locking pin rotated 45 degrees.

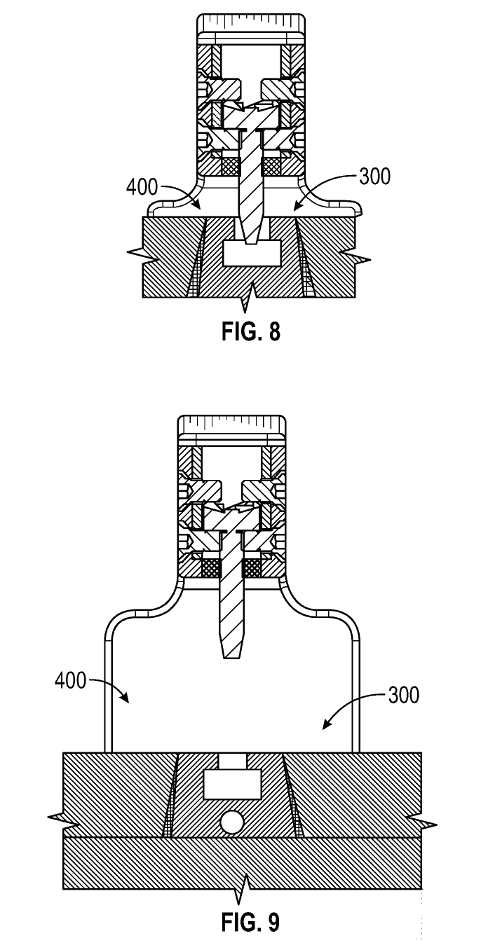

FIG. 8 depicts an embodiment with the lifting arm raised and the locking pin rotated 45 degrees further, as compared to the locking pin position shown in FIG. 7.

FIG. 9 depicts the lifting arm raised.

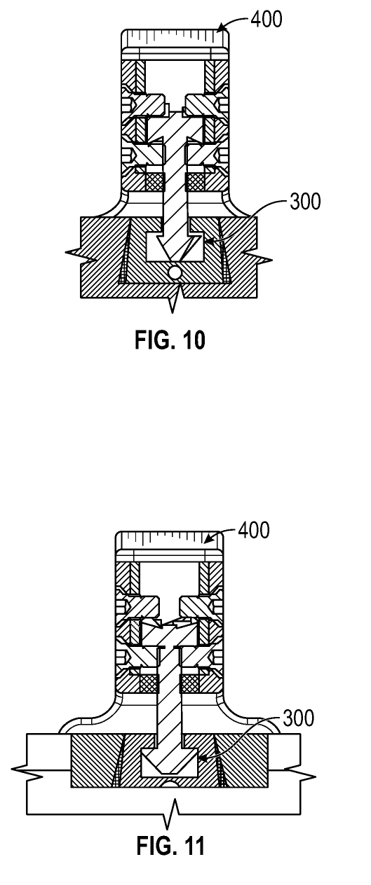

FIG. 10 depicts the lifting arm lowered and the locking pin rotated 45 degrees.

FIG. 11 depicts the lifting arm is a raised position with the locking pin rotated an additional 45 degrees. The locking pin is back in the locked position.

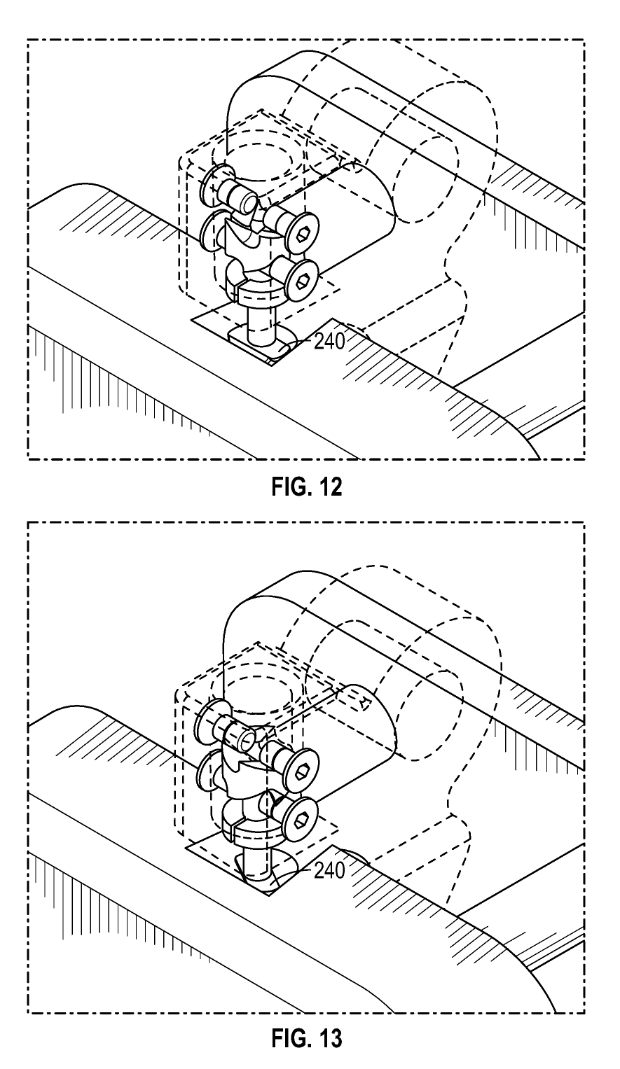

FIG. 12 depicts a top perspective view of FIG. 6.

FIG. 13 depicts a top perspective view of FIG. 7.

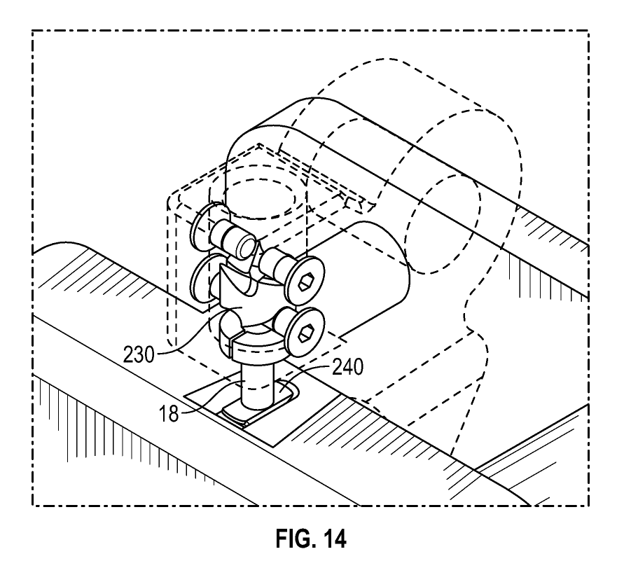

FIG. 14 depicts a top perspective view of FIG. 8.

FIG. 15 depicts a top perspective view of FIG. 9.

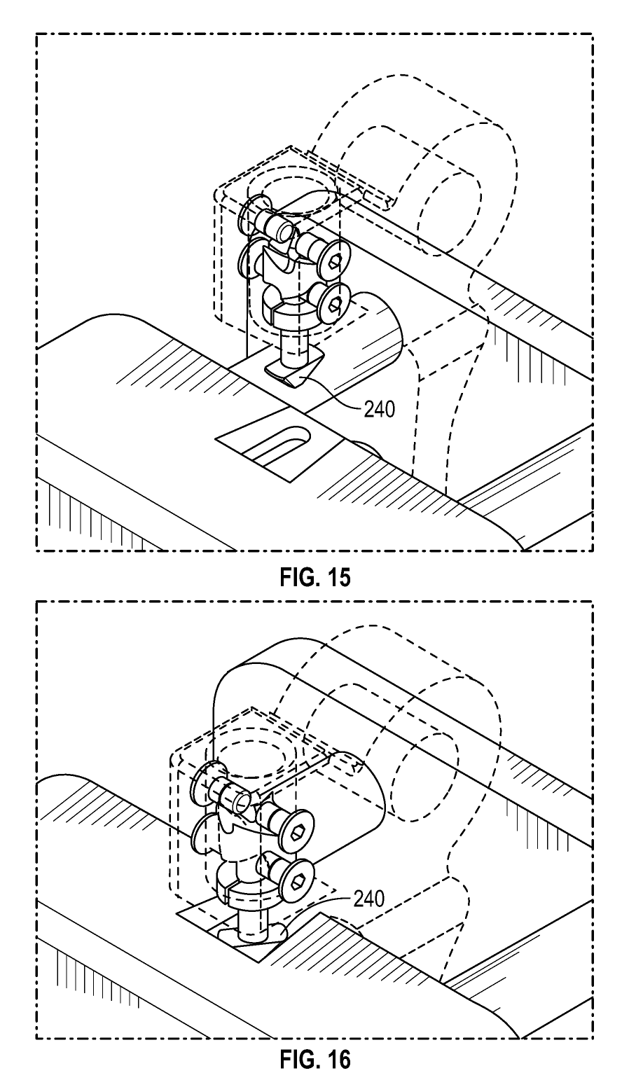

FIG. 16 depicts a top perspective view of FIG. 10.

What is claimed is:

1. A gripping system (100) comprising:
a) a back plate (3) attached to a center sliding plate (7) with rotation of the back plate to the center sliding plate urged by a lifting pin assembly (200) in pivotal attachment to the center sliding plate;
b) a cam plate (14) containing the lifting pin assembly and the cam plate attached to superior ends of the center sliding plate and the back plate.

2. The system of claim 1 wherein the lifting pin assembly comprises:
a) a lifting pin (19) having a top half section (205) with the top half section defining an upper void (210) with the upper void accepting a cylinder (21)
b) a locking pin (18) axially dispose within the upper void, the locking in comprising an upper rotational pivot plane (230) attached to a shaft section and the shaft section attached to a triangular lock head (240).

3. The system of claim 2 wherein the lifting pin assembly further comprises:
a) a first and second lower pivot mount (220) attached to a lower end of the lifting pin, the first and second lower pivot mounts defining a plurality of voids, with the plurality of voids containing an inner pressure wheel (11) a first and second outer pressure wheel (9) and a shaft (10).

4. The system of claim 3 wherein a lower portion of the center sliding plate and a lower portion of the cam plate are attached by a bottom extension spring (13).
